(19) United States
(12) Patent Application Publication
(10) Pub. No.: US 2011/0184779 A1
(43) Pub. Date: Jul. 28, 2011

(54) DYNAMIC ON-LINE LEARNING SYSTEM FOR ELECTRONIC COUPONS USING ON-LINE AUCTIONS

(75) Inventors: Parul A. Mittal, Gautam Nagar (IN); Abhinanda Sarkar, Panchsheel Park (IN); K. Balaji, Malaviya Nagar (IN)

(73) Assignee: International Business Machines Corporation, Armonk, NY (US)

(21) Appl. No.: 13/080,346

(22) Filed: Apr. 5, 2011

Related U.S. Application Data
(63) Continuation of application No. 09/686,641, filed on Oct. 10, 2000.

(51) Int. Cl. G06Q 10/00

(52) U.S. Cl. 705/7.31

(57) ABSTRACT

A system, method, and computer program product implementing the method for generating promotional scheme parameters for issuing redeemable electronic coupons, wherein the method comprises automatically obtaining market demand data from defined sources of online auctions, conducting online auctions using defined parameters for specified goods and/or services to obtain market demand data, and storing and analyzing the market demand data obtained from the online auctions or the conducted auctions to estimate demand and calculate promotion scheme parameters for issue of redeemable electronic coupons.

### CROSS-REFERENCE TO RELATED APPLICATIONS

This application is a Continuation of U.S. application Ser. No. 09/686,641 filed Oct. 10, 2000, the complete disclosure of which, in its entirety, is herein incorporated by reference.

### FIELD OF THE INVENTION

This invention relates to Dynamic on-line learning system for electronic coupons using on-line auctions.

### BACKGROUND OF THE INVENTION

Coupons have been used since a long time as a sales promotion tool to retain loyal customers, to increase the repurchase rate of occasional buyers, to attract new buyers, to manage inventory and to gain market. They also provide means of price discrimination. C. Narasimhan in “A Price Determination Theory of Coupons”, Marketing Science, 1984, discusses the results of a statistical study in which price elasticities of demand were estimated for various products and a number of users. The study confirms that the users of coupons tend to have more price sensitive demands than non-users of coupons. It also shows that the elasticities differ for two groups of consumers and that it varies from one product to another.

For an effective use of coupons as a sales promotional tool, it is necessary to have a system for defining the parameters of the coupon scheme including identification of products or services for which the coupons should be offered, nature of discounts to be offered, amounts of discounts, market segment for the promotion, duration of scheme and identification of methods of offering the scheme.

In U.S. Pat. No. 5,832,457, a system is proposed for automatically distributing coupons at a physical checkout stand, based on a combination of customer supplied data, prior customer behavior and present shopping activity. The paper “Distributing E-Coupons on the Internet” by Anand Rangchari et. al. in Proceedings of Inet, June 99, describes an e-coupon delivery system that offers e-coupons to shoppers based on shopper's demographic information, shopper's purchases, coupons already possessed by the shopper and shopper's clickstream.

However, all these systems are deficient in effectiveness as they are based on data from a limited database—namely the existing customers of the product or service. In fact for a product or service, which is newly introduced, the available database is essentially non-existent in such schemes.

It is interesting to note that auctions are price determination vehicles. How a fair or efficient price is determined depends on the bidding process used. P. Milgrom in “Auctions and bidding: a primer”, Journal of Economic Perspectives, 1989, discusses the impact of the bidding process on price formation. More details can be found in the papers reprinted in Klemperer (ed.) “The Economic Theory of Auctions”, 1999. It is by now recognized that auctions provide a fair and open basis for competitive pricing for even non-standard items such as radio frequencies.

On-line auctions on the Internet function more like exchanges. The requirement that there be a physical meeting place is removed. As a result, many more types of items can be profitably (for the auctioneer) auctioned. Even consumer items are now regularly auctioned and exchanged by people who have the added capability of attending several auctions by remote. D. Lucking-Reilly in “Auctions on the Internet: what's being auctioned, and how”, working paper, Vanderbilt University, 1999, discusses the on-line auctions available. Thus there is now the opportunity to have promotions on items being auctioned. More than collectibles are being auctioned and coupons have a brand new distribution outlet.

### THE OBJECT AND SUMMARY OF THE INVENTION

The object of this invention is to overcome the disadvantages of existing systems of defining coupon schemes by utilizing demand data from online auction sources.

To achieve the said objective this invention provides in 1. In a computing system comprising at least one processor, associated memory, storage and input/output devices, said computing system being connected to a network of computing systems and being used to generate promotional scheme parameters for electronic coupons characterized in that said system includes:
means for automatically obtaining market demand data from defined sources of online auctions,
means for conducting online auctions using defined parameters for specified goods and/or services for getting market information,
means for storing and analyzing the data obtained from said online auctions or said conducted auctions to estimate demand and calculate promotion scheme parameters for issue of redeemable electronic coupons.

The means for obtaining demand data from online auction includes ability to access different types of auctions such as sealed-bid auctions, open-cry auctions, Dutch auctions and reverse auctions.

The said means for obtaining the demand data from online auctions is through software means to start capturing the demand data from the time the auction starts to the time it ends.

The demand data comprises of the names of products or services being auctioned, the bids from a plurality of bidders participating in an auction, the reserve prices of the auction, the duration of the auction, the total number of bids received for each product or service, market segment of the bidders.

The demand data further includes the information specific to particular auction types such as the opening price and the successive decrements in case of descending (“Dutch”) auctions.

The said means for storing and analyzing the demand data is a statistical means that generates the promotion scheme parameters for different market segments. The said statistical means includes:
means for estimating the market demand curve and the price elasticity for an auction item or product or service from a plurality of demand data sources, and
means for determining if an item or product or service is amenable to price discrimination based on said estimated demand curve and price elasticity.

The said promotion scheme parameters include the collection of items or products or services to be discounted, the amount of discount, the nature of discount, market segment for the promotion scheme, duration of promotion scheme and identification of methods of offering the scheme.

The said means for estimating the market demand curve is by considering the fractional demand at a particular price, the fraction of population that is willing to pay the price, computing the product of the fractional demand and the demand at zero prices i.e. the size of the market willing to buy the product at zero prices.

The above system further comprises means for suggesting the discounting of a substitute of the product or item or service being auctioned.

The said item being auctioned is a competitor's item and the substituted product is promoter's own.

The means for obtaining the demand data includes the ability to cover multiple market segments and suggest a promotion scheme targeted at different market segments.

The above system further includes means for suggesting discounting of a cross selling or an up selling product to the product being auctioned.

The said means for estimating the demand curve uses the winning bid and the highest bids of all the bidders for the case of open-cry or ascending auctions while for the descending auctions namely, Dutch auctions only the winning bid is used.

The said means for estimating the market demand curve for an individual item uses demand data where multiple units of items are auctioned.

The said means for estimating market demand curve uses the quantity demanded by an individual buyer at various price levels.

The said means for estimating the market demand curve information from the online auctions is used to determine the decrement size in a descending or Dutch auction.

The above system further includes means for the user to configure the sources of online demand data as well as the parameters for conducting online auctions on a plurality of products on specified URLs.

The said means for storing and analyzing the demand data also receives the data from the electronic coupon issuing system as a feedback in order to dynamically learn, adapt and improve the promotional parameter estimation system.

The instant invention further provides a method for generating promotional scheme parameters using electronic coupons, characterized in that it includes:
automatically obtaining market demand data from defined sources of online auctions,
conducting online auctions using defined parameters for specified goods and/or services,
storing and analyzing the market demand data obtained from said. online auctions or said conducted auctions to estimate demand and calculate promotion scheme parameters for issue of redeemable electronic coupons.

The obtaining demand data from online auction includes ability to access different types of auctions such as sealed-bid auctions, open-cry auctions, Dutch auctions and reverse auctions.

The obtaining the demand data from online auctions is through software to start capturing the demand data from the time the auction starts to the time it ends.

The demand data comprises of the names of products or services being auctioned, the bids from a plurality of bidders participating in an auction, the reserve prices of the auction, the duration of the auction, the total number of bids received for each product or service, market segment of the bidders.

The demand data further includes the information specific to particular auction types such as the opening price and the successive decrements in case of descending (“Dutch”) auctions.

The storing and analyzing of the demand data is by a statistical method that generates the promotion scheme parameters for different market segments.

The said statistical method includes:
estimating the market demand curve and the price elasticity for an auction item or product or service from a plurality of demand data sources, and
determining if an item or product or service is amenable to price discrimination based on said estimated demand curve and price elasticity.

The said promotion scheme parameters include the collection of items or products or services to be discounted, the amount of discount, the nature of discount, market segment for the promotion scheme, duration of promotion scheme and identification of methods of offering the scheme.

The estimating of the market demand curve is by considering the fractional demand at a particular price, the fraction of population that is willing to pay the price, computing the product of the fractional demand and the demand at zero prices i.e. the size of the market willing to buy the product at zero prices.

The above method further comprises suggesting the discounting of a substitute of the product or item or service being auctioned.

The said item being auctioned is a competitor's item and the substituted product is promoter's own.

The obtaining of the demand data includes the ability to cover multiple market segments and suggest a promotion scheme targeted at different market segments.

The above method further comprises suggesting discounting of a cross selling or an up selling product to the product being auctioned.

The estimating of the demand curve uses the winning bid and the highest bids of all the bidders for the case of open-cry or ascending auctions while for the descending auctions namely, Dutch auctions only the winning bid is used.

The estimating of the market demand curve for an individual item uses demand data where multiple units of items are auctioned.

The estimating of market demand curve uses the quantity demanded by an individual buyer at various price levels.

The estimating of the market demand curve information from the online auctions is used to determine the decrement size in a descending or Dutch auction.

The above method further includes method for the user to configure the sources of online demand data as well as the parameters for conducting online auctions on a plurality of products on specified URLs.

The storing and analyzing the demand data also receives the data from the electronic coupon issuing system as a feedback in order to dynamically learn, adapt and improve the promotional parameter estimation system.

A computer program product comprising computer readable program code stored on computer readable storage medium embodied therein for causing a computer to generate promotional scheme parameters using electronic coupons comprising:
computer readable program code configured for automatically obtaining market demand data from defined sources of online auctions,
computer readable program code configured for conducting online auctions using defined parameters for specified goods and/or services,
computer readable program code configured for storing and analyzing the data obtained from said online auctions or said conducted auctions to estimate demand and calculate promotion scheme parameters for issue of redeemable electronic coupons.

The said computer readable program code configured for obtaining demand data from online auction includes ability to access different types of auctions such as sealed-bid auctions, open-cry auctions, Dutch auctions and reverse auctions.

The said computer readable program code configured for obtaining the demand data from online auctions is through software to start capturing the demand data from the time the auction starts to the time it ends.

The demand data comprises of the names of products or services being auctioned, the bids from a plurality of bidders participating in an auction, the reserve prices of the auction, the duration of the auction, the total number of bids received for each product or service, market segment of the bidders.

The demand data further includes the information specific to particular auction types such as the opening price and the successive decrements in case of descending (“Dutch”) auctions.

The said computer readable program code configured for storing and analyzing the demand data is a statistical computer readable program code that generates the promotion scheme parameters for different market segments.

The said statistical computer readable program code includes:
computer readable program code configured for estimating the market demand curve and the price elasticity for an auction item or product or service from a plurality of demand data sources, and
computer readable program code configured for determining if an item or product or service is amenable to price discrimination based on said estimated demand curve and price elasticity.

The said promotion scheme parameters include the collection of items or products or services to be discounted, the amount of discount, the nature of discount, market segment for the promotion scheme, duration of promotion scheme and identification of methods of offering the scheme.

The said computer readable program code configured for estimating the market demand curve is by considering the fractional demand at a particular price, the fraction of population that is willing to pay the price, computing the product of the fractional demand and the demand at zero price i.e. the size of the market willing to buy the product at zero price.

The above computer program product further comprises computer readable program code configured for suggesting the discounting of a substitute of the product or item or service being auctioned.

The said item being auctioned is a competitor's item and the substituted product is promoter's own.

The computer readable program code configured for obtaining the demand data includes the ability to cover multiple market segments and suggest a promotion scheme targeted at different market segments.

The above computer program product further includes computer readable program code configured for suggesting discounting of a cross selling or an up selling product to the product being auctioned.

The said computer readable program code configured for estimating the demand curve uses the winning bid and the highest bids of all the bidders for the case of open-cry or ascending auctions while for the descending auctions namely, Dutch auctions only the winning bid is used.

The said computer readable program code configured for estimating the market demand curve for an individual item uses demand data where multiple units of items are auctioned.

The said computer readable program code configured for estimating market demand curve uses the quantity demanded by an individual buyer at various price levels.

The said computer readable program code configured for estimating the market demand curve information from the online auctions is used to determine the decrement size in a descending or Dutch auction.

The above computer program product further includes computer readable program code configured for the user to configure the sources of online demand data as well as the parameters for conducting online auctions on a plurality of products on specified URLs.

The said computer readable program code configured for storing and analyzing the demand data also receives the data from the electronic coupon issuing system as a feedback in order to dynamically learn, adapt and improve the promotional parameter estimation system.

The system is extended to learn about the state of online markets by mining information from current and past operations of similar online markets in order to devise differential strategies for various market segments.

The said system is also used to do optimal inventory management.

The said system is integrated with an online electronic coupon generation system to provide a complete system for issuing of redeemable electronic coupons.

The said generated market demand curve and promotion parameters are used to provide a data discovery service to a plurality of buyers in various market segments who use it for generating redeemable electronic coupons for their products or services.

### BRIEF DESCRIPTION OF THE DRAWINGS

The invention will now be described with reference to the accompanying drawings.

FIG. 1 shows the basic structure of the system, according to this invention.

FIG. 2 shows the operation for a single market segment.

FIG. 3 shows the operation for multiple market segments.

### DETAILED DESCRIPTION OF THE DRAWINGS

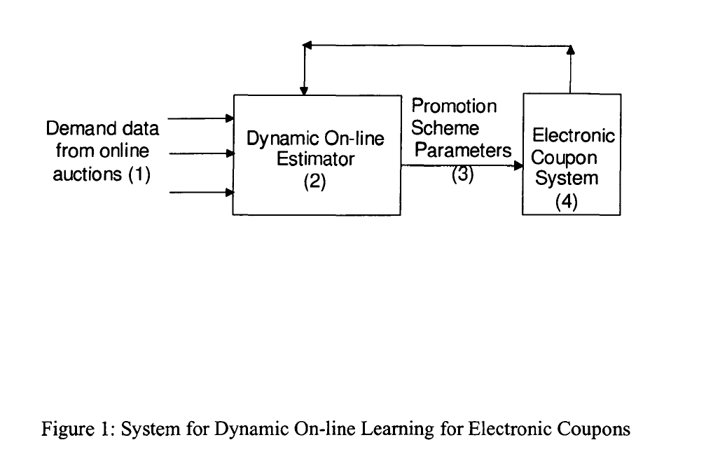

As shown in FIG. 1, the system according to this invention termed here as a ‘dynamic online estimator’ (2), obtains demand data from online auctions (1) for a desired product or service, stores and analyses the received data and produces promotion scheme parameters (3), as an output to an electronic coupon generation system (4). The output from the electronic coupon generation system (4) is also fed back as an input to the ‘dynamic online estimator’ (2) to provide feedback in order to dynamically learn, adapt and improve the generation of promotional parameters. The said feedback is the change in the product sales quantity during promotion or the number of new customers and the like.

The ‘Dynamic On-Line Estimator’(2) is a statistical procedure that takes possibly censored data from a plurality of on-line auctions and outputs the promotion scheme parameters for different market segments.

The demand data from the online auctions (1) comprises of the names of products or services being auctioned, the bids from a plurality of bidders participating in an auction, the reserve prices of the auction, the duration of the auction, the total number of bids received for each product or service, market segment of the bidders etc. The demand data also includes the information specific to particular auction types such as the opening p-rice and the successive decrements in case of descending ('Dutch') auctions.

The estimator (2) estimates the market demand curve and the price elasticity for an auctioned item, a product or a service, from each individual auction's data. The market demand curve is the response of a collective of potential buyers to changes in price. It determines if the item is amenable to price discrimination based on the demand curve and the price elasticity information from a plurality of auctions data. For instance, it is well recognized that price discrimination is successful in markets that are segmented with each segment having distinct price elasticity. So if the demand data is from a plurality of market segments and different segments have distinct price elasticities, it outputs the promotion scheme parameters for each market segment. Even if the data were from the same market segment, if the demand curve suggested a large increase in item sales for a small price drop, promotion scheme parameters are suggested accordingly.

Promotion scheme parameters (3) comprise the item or collective of items to be discounted, the amount of discount, the nature of the discount e.g. free gifts, price packs, loyalty points and order discount, a market segment for the promotion scheme, the duration of the promotion scheme, appropriate instance to offer the discount, how to offer the discount etc.

Market segment is defined by a plurality of multi-valued attributes such as the demographic parameters like age group, sex, marital status, household income and hobbies or the geographic like city, state and country. Some of these attributes may be non-quantitative and hence fuzzy e.g. time of the day, the season, bidder's cultural upbringing, etc. In India for example, there is a concept of ‘boni’ which is the money earned on the first transaction of every day. It is believed that once the ‘boni’ occurs, the rest of the day will be fruitful. Thus it is usually seen that the merchants accept lower prices in beginning of day to get the ‘boni’ and hence the customer's mind-set is also to pay a lower price.

An Electronic Coupon System that takes as input the promotion scheme parameters and generates electronic coupons that are redeemable online according to the received promotion scheme parameters. For instance if the promotion scheme parameters suggest 20% discount on a product for people in age group 12 to 19, the electronic coupon system generates unique’ unforgettable coupons that offer 20% discount on the suggested product and offers it to the people in age group 12 to 19.

In one embodiment of this invention, demand data is the bid values from various bidders participating in a sealed bid auction. The demand curve can be estimated from this demand data by considering the fractional demand at price ‘p’ i.e. the function of population that is willing to pay a price ‘p’ to be the fraction of people with bids higher than ‘p’. Assuming a size ‘N’ of the market that is willing to buy the products at zero price, the total demand at price ‘p’ can be computed as the product of the fractional demand and ‘N’. These point estimates for different price values can be smoothed to a continuous demand curve using statistical smoothing techniques as discussed by J. S. Simon off in “Smoothing Methods in Statistics”, 1996. The price elasticity can now be obtained by determining the slope of the demand curve. If the price elasticity suggests that a small decrease in product price results in a large increase in product demand, then the system decides that the product is amenable to price discrimination. It suggests that the product be discounted by an automatically determined amount. The system may also suggest that the electronic coupon should be offered only to the customer who shows hesitant interest in the product.

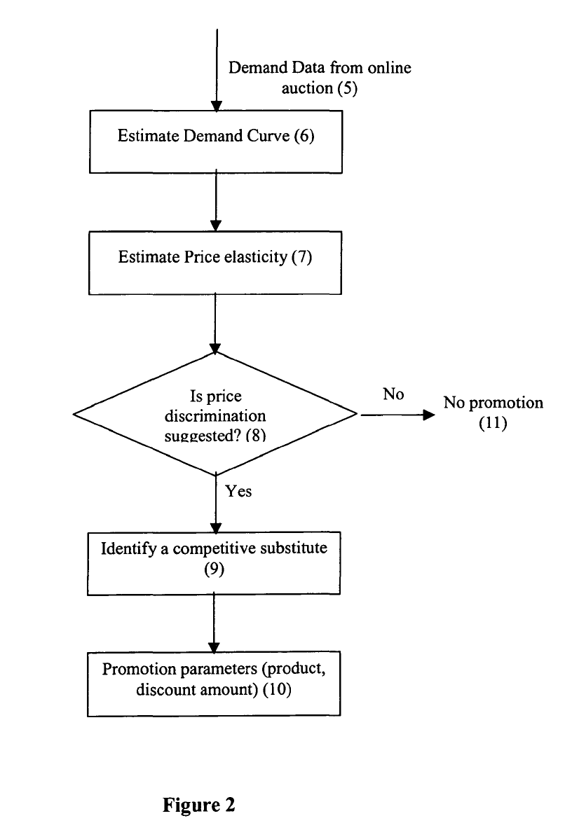

FIG. 2 shows another embodiment of this invention in which the system is used to identify a comparative substitute of the product being auctioned as a target for promotion using e-coupons. The demand data from the online auctions (5) is used to estimate a demand curve (6) and estimate price elasticity (7) for the auctioned products. If the price elasticity obtained suggests price discrimination (8) then a competitive substitute is identified (9) for which promotion parameters for the e-coupon scheme are generated (10). If the price elasticity does not suggest any price discrimination, the promotion scheme is not generated (11). Usually the increase in demand is due to brand switching rather than more buying as discussed by S. Gupta in “Impact of Sales Promotion on When, What, and How Much to Buy, Journal of Marketing Research, 25, 203-238, 1988. Thus a manufacturer can use this system to obtain the demand curve of a competitor's product and then discount its own substitute product accordingly

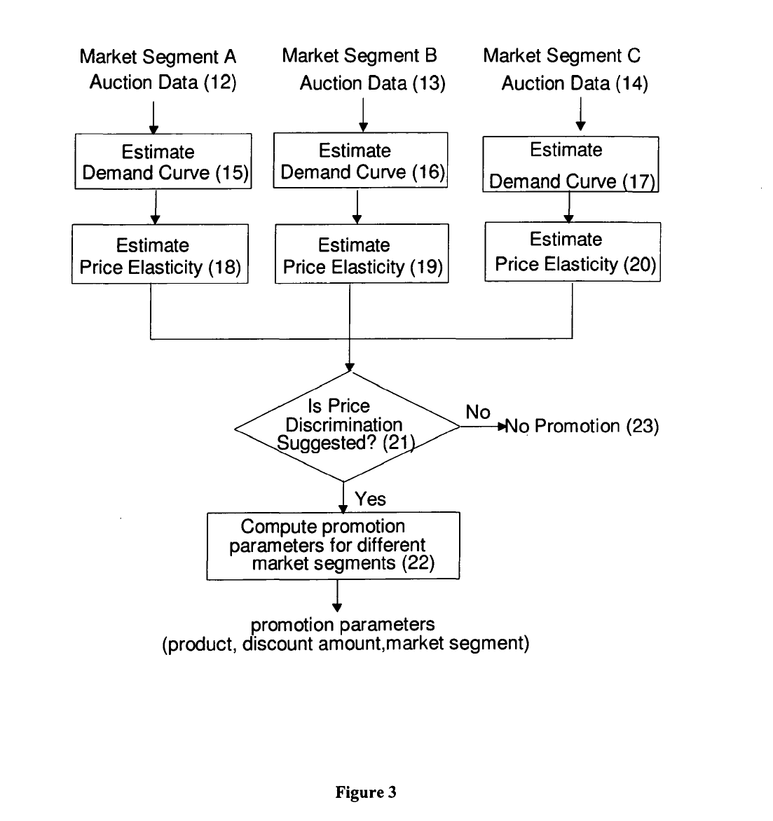

In FIG. 3, the demand data from the online auctions (12, 13 & 14) is obtained from multiple market segments ‘A’, ‘B’, and ‘C’. In this case, the demand curves (15, 16 & 17) and the price elasticity (18, 19 & 20) for each market segment is determined. If the price elasticities of market segments ‘A’,‘B’, and ‘C’ suggest price discrimination (21) then the system computes promotion parameters (22) for the different market segments. If the price elasticities do not suggest any price discrimination, no action is taken (23). On the other hand, if the price elasticity for the said market segments suggests that a drop in price by ‘pea)’ for market segment ‘A’ and a drop in price ‘pub)’ for market segment ‘B’ will increase the demand significantly whereas the curve is more or less constant for market segment ‘C’, then the system suggests that the product be discounted by pea) only for customers in market segment's′ and by p(b) for customers in market segment ‘B’. It suggests no discount for market segment ‘C’ customers. So a promotion scheme targeted to different market segments is suggested. The demand data from different market segments can be obtained by conducting auctions at appropriate web-site e.g. sports specific site for the ‘interested in sports’ market segment or health related site for the ‘health conscious’ market segment and so on.

In another embodiment of this invention, the system suggests that a cross selling or an up-selling product of the product being auctioned should be discounted. A cross-selling product is different from the product being sold but is associated with it. For example, a table to keep a computer is a cross-selling product of the computer. An up-selling product on the other hand is closer to being an accessory of the product being sold or related to the product being sold. For example, a printer is an up-selling product to a computer. Thus a manufacturer can use this system to obtain the demand curve of a product and then discount items that are cross-selling or up-selling. The idea is to offer a combination of products at the price where the demand is high by discounting the cross-selling product rather than the original product.

Yet in another embodiment of this invention, demand data can be from different types of auctions like sealed-bid auctions, open-cry auctions, Dutch auctions and reverse auctions. In case of open-cry or ascending auctions, demand curves can be estimated using the winning bid and the highest bids of all the bidders. Data from a plurality of ascending auctions, for same market segment, can be combined for better demand curve estimation. In case of descending auctions, only the winning bid is available. A demand curve can be estimated using data from a plurality of descending auctions along with some model for the price distribution.

In a further embodiment of this invention, the demand data is used to do optimal inventory management. Using the demand curve, the price that maximizes the revenue is calculated as being the point maximizing the product of price and product quantity. The product is first sold at this revenue maximizing price. The remaining inventory is then sold at the price corresponding to the remaining product quantity in the demand curve. Thus electronic coupons are issued for clearing inventory to discount the product.

In another embodiment of this invention, an individual demand curve is estimated. The individual demand curve is the quantity demanded by an individual at a particular price such demand curve can be estimated from auction data where multiple units of items are auctioned. This demand curve can be used for promotions like ‘buy one get one free’, price packs, quantity discounts etc. Such demand curve can be estimated from demand data where multiple units of items are auctioned. In such auctions, the data are the bids from the bidders in the form of a ‘price, quantity’ pairs. As before, data from a plurality of auctions can be combined to Yield better estimation.

In another embodiment of this invention, the demand curve information from the auctions can be used for determine the decrement size in a descending or Dutch auction. In a Dutch auction the price is dropped constantly in some steps until an on-line bidder accepts a price or the reserve price is reached. This can be visualized as an electronic coupon whose value increases with time. The demand curve estimated from some demand data can be used to determine the prices at which the demand is high. The price can then be dropped accordingly in a Dutch auction rather than in constant steps.

In another embodiment of this invention, the sources of on-line demand data can be configured in the system. The system then obtains the demand data from the configured URLs by observing the ongoing on-line auction. The system can set up software agents to start capturing the demand data from the time that the auction starts to the time it ends. The system can also be configured to conduct auctions on a plurality of products on configured URLs for a specified duration, reserve price and other auction-specific configurations. With this the complete system can be automated from observing the demand data, analyzing the data, estimating demand, calculating promotion scheme parameters and issuing electronic coupons accordingly.

In a more general embodiment of this invention, the method and apparatus can be extended to learn about the state of on-line markets by mining information from current and past operations of similar on-line markets. Such information can be used to assess differential activity across different market segments, be they auctions or otherwise. The information can be used to devise differential strategies for these segments, be they coupon-based or otherwise.

1. A computing system comprising at least one processor, associated memory, storage and input/output devices, said computing system being connected to a network of computing systems and being used to generate promotional scheme parameters for electronic coupons, said processor:
automatically obtaining market demand data from defined sources of online auctions;
conducting online actions using defined parameters for specified goods and/or services for getting market information, wherein said parameters comprise non-quantitative attributes comprising cultural attributes of bidders of said online auctions;
storing and analyzing the market data demand obtained from said online auctions or said conducted auctions to estimate demand and calculate promotion scheme parameters for issue of redeemable electronic coupons, wherein said storing and analyzing the market demand data is a statistical process that generates promotion scheme parameters for different market segments and receives the data from an electronic coupon issuing system as a feedback in order to dynamically learn, adapt and improve generation of said promotion scheme parameters; and
generating said redeemable electronic coupons.

2. The system of claim 1, wherein said obtaining of said market demand data captures the market demand data from the time the auction starts to the time it ends.

3. The system of claim 1, wherein said statistical process includes:
estimating the market demand curve and the price elasticity for an auction item or product or service for a plurality of demand data sources, and
determining if an item or product or service is amenable to price discrimination based on said estimated demand curve and price elasticity.

4. The system of claim 3, wherein said estimating the market demand curve comprises considering the fractional demand at a particular price, the fraction of population that is willing to pay the price, computing the product of the fractional demand and the demand at zero price including the size of the market willing to buy the product at zero price.

5. The system of claim 3, wherein said estimating the market demand comprises using the quantity demanded by an individual buyer at various price levels.

6. The system of claim 4, wherein said estimating the market demand curve comprises using information from the online auctions to determine the decrement size in a descending or Dutch auction.

7. The system of claim 1, further comprising configuring the sources of online demand data as well as the parameters for conducting online auctions on a plurality of products on specified uniform resource locators (URLs).

8-14. (canceled)

15. A computer program product comprising computer readable program code stored on non-transitory computer readable storage medium for causing a computer to generate promotional scheme parameters using electronic coupons comprising:
computer readable program code configured for automatically obtaining market demand data from defined sources of online auctions;
computer readable program code configured for conducting online auctions using defined parameters for specified goods and/or services, wherein said parameters comprise non-quantitative attributes comprising cultural attributes of bidders of said online auctions;
computer readable program code configured for storing and analyzing the market demand data obtained from said online auctions or said conducted auctions to estimate demand and calculate promotion scheme parameters for issue of redeemable electronic coupons, wherein said computer readable program code configured for storing and analyzing of the market demand data is a statistical computer readable program code that generates promotion scheme parameters for different market segments, and wherein storing and analyzing the market demand data receives the data from an electronic coupon issuing system as a feedback in order to dynamically learn, adapt and improve generation of said promotion scheme parameters; and
computer readable program code configured for generating said redeemable electronic coupons.

16. The computer program product of claim 15, wherein said computer readable program code configured for obtaining the market demand data from online auctions is used from the time the auction starts to the time it ends.

17. The computer program product of claim 15, wherein said statistical computer readable program code includes:
computer readable program code configured for estimating the market demand curve and the price elasticity for an action item or product or service from a plurality of demand data sources, and
computer readable program code configured for determining if an item or product or service is amenable to price discrimination based on said estimated demand curve and price elasticity.

18. The computer program product of claim 17, wherein said computer readable program code configured for estimating the market demand curve considers the fractional demand at a particular price, the fraction of population that is willing to pay the price, computing the product of the fractional demand and the demand at zero price including the size of the market willing to buy the product at zero price.

19. The computer program product of claim 17, wherein said computer readable program code configured for estimating market demand curve uses the quantity demanded by an individual buyer at various price levels.

20. The computer program product of claim 17, wherein said computer readable program code configured for estimating the market demand curve information from the online auctions determines the decrement size in a descending or Dutch auction.

21. A computing system comprising at least one processor, associated memory, storage and input/output devices, said computing system being connected to a network of computing systems and being used to generate promotional scheme parameters for electronic coupons, said processor:
automatically obtaining market demand data from defined sources of online auctions;
conducting online actions using defined parameters for specified goods and/or services for getting market information, wherein said parameters comprise non-quantitative attributes comprising cultural attributes of bidders of said online auctions;
storing and analyzing the market data demand obtained from said online auctions or said conducted auctions to estimate demand and calculate promotion scheme parameters for issue of redeemable electronic coupons, wherein said storing and analyzing the market demand data is a statistical process that generates promotion scheme parameters for different market segments and receives the data from an electronic coupon issuing system as a feedback in order to dynamically learn, adapt and improve generation of said promotion scheme parameters; and
generating said redeemable electronic coupons,
wherein said statistical process includes:
estimating the market demand curve and the price elasticity for an auction item or product or service for a plurality of demand data sources, and
determining if an item or product or service is amenable to price discrimination based on said estimated demand curve and price elasticity.

22. The system of claim 21, wherein said obtaining of said market demand data captures the market demand data from the time the auction starts to the time it ends.

23. The system of claim 21, wherein said estimating the market demand curve comprises considering the fractional demand at a particular price, the fraction of population that is willing to pay the price, computing the product of the fractional demand and the demand at zero price including the size of the market willing to buy the product at zero price.

24. The system of claim 21, wherein said estimating the market demand comprises using the quantity demanded by an individual buyer at various price levels.

25. The system of claim 21, wherein said estimating the market demand curve comprises using information from the online auctions to determine the decrement size in a descending or Dutch auction.

26. The system of claim 21, further comprising configuring the sources of online demand data as well as the parameters for conducting online auctions on a plurality of products on specified uniform resource locators (URLs).
